(19) United States
(12) Patent Application Publication
(10) Pub. No.: US 2009/0094684 A1
(43) Pub. Date: Apr. 9, 2009

(54) Relay server authentication service

(75) Inventors: Malar Chinnusamy, Redmond, WA (US); Wajih Yahyaoui, Bellevue, WA (US); Neil Deason, Seattle, WA (US); Tony Bell, Carnation, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/973,113

(22) Filed: Oct. 5, 2007

(51) Int. Cl. G06F 21/20

(52) U.S. Cl. 726/4

(57) ABSTRACT

A relay server authentication service for a relay server is described. An apparatus may include a proxy server to receive an authentication request for client authentication information from a first client to traverse a network address translation device. The apparatus may further include a relay server with a relay server authentication service module. The relay server authentication service module may be arranged to receive the authentication request from the proxy server, generate the client authentication information for the first client, and send an authentication response with the client authentication information to the first client through the proxy server. Other embodiments are described and claimed.

### BACKGROUND

Network Address Translation (NAT) refers to a technique that involves re-writing the source and/or destination addresses of network packets as they pass through a router or firewall. A NAT device, such as a NAT-enabled router, allows multiple hosts on a private network to access a public network such as the Internet using a single public network address, such as an Internet Protocol (IP) address. A NAT device, however, sometimes makes it difficult to provide connectivity between a device on a private network and a device on a public network.

To compensate for end-to-end connectivity problems, certain protocols have been developed to allow a public client to traverse a NAT device. One such protocol is the Session Utilities for NAT (STUN) protocol. The STUN protocol allows a public client to obtain a transport address which may be useful for receiving packets from a peer. Addresses obtained by STUN, however, may not be usable by all peers. The STUN addresses may not work depending on the topological conditions of the network. To augment or enhance the STUN protocol, a public-accessible relay server may be implemented to relay packets of media information between any peers that can send packets to the public Internet, including public peers and private peers. The Traversal Using Relay NAT (TURN) protocol is one protocol designed to allow a client to obtain IP addresses and ports from such a relay server. For security considerations, however, the TURN protocol requires authentication operations prior to authorizing use of the relay server by a client. Accordingly, there may be a need for improved security techniques to authenticate clients to communicate media information through a relay server, thereby improving connectivity across multiple networks implementing various NAT devices.

### SUMMARY

Various embodiments may be generally directed to a relay server authentication service for a relay server. Some embodiments may be particularly directed to security techniques for sharing cryptographic or authentication information between clients and a relay server in a heterogeneous communications system comprising both public networks, private networks and a proxy server. In one embodiment, the relay server may be implemented as a STUN server and/or a TURN server to allow NAT traversal by various public and private clients.

In one embodiment, for example, a communications system may include a proxy server and a relay server. The proxy server may be arranged to receive an authentication request for client authentication information from a first client to traverse a network address translation device or a corporate firewall. The relay server may be arranged to communicate packets of media information between the first client and a second client. The first and second clients may comprise many different types of clients, including a respective public client and private client. The relay server may further have a relay server authentication service (RSAS) module. The RSAS module may be arranged to receive the authentication request from the proxy server, generate the client authentication information for the first client, and send an authentication response with the client authentication information to the first client through the proxy server. Communications between the various network elements, including the first client, the second client, the proxy server, and the relay server, and any other intermediate elements, may be accomplished using any number of cryptographic or security techniques to form a secure communications channel to implement various security measures. Other embodiments are described and claimed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates one embodiment of a communication system.

FIG. 2 illustrates one embodiment of a logic flow.

FIG. 3 illustrates one embodiment of a message flow.

FIG. 4 illustrates one embodiment of a computing system architecture.

### DETAILED DESCRIPTION

Various embodiments may be generally directed to a relay server authentication service for a relay server to allow public and/or private clients to traverse a NAT device to communicate packet-switched data. In one embodiment, for example, a relay server may be implemented as a STUN server and/or a TURN server to allow traversal of a NAT device or a firewall by various public and/or private clients. To operate using the TURN protocol, the relay server needs to authenticate the clients prior to allowing the clients to begin communicating packets of media information through the relay server. The relay server typically performs authentication operations for the clients using a shared secret between the relay server and the respective clients. For example, the relay server typically generates the shared secret, and distributes the shared secret to the various clients. In some cases, however, it may be difficult for a public client to securely obtain the shared secret generated by the relay server. Consequently, some embodiments are directed to a security scheme and architecture for generating and distributing security tokens for use by public clients residing on a public network and private clients residing on a private network, where the private network has controlled access through a NAT device, such as a NAT-enabled router. The security scheme and architecture implements a proxy server to establish a secure communications channel between the requesting clients and the relay server in order to communicate various security tokens. The security tokens may be used to establish and manage connections to the relay server by both public and private clients, thereby traversing the NAT device and providing improved end-to-end connectivity for multimedia communications between heterogeneous communication networks.

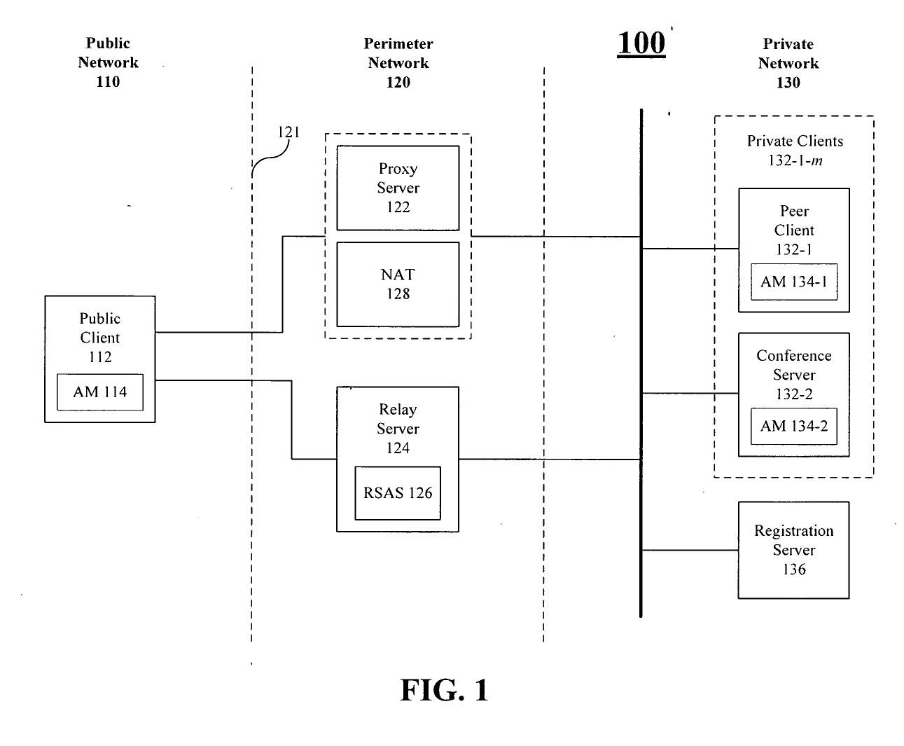

FIG. 1 illustrates one embodiment of a communications system 100. The communications system 100 may represent a general system architecture suitable for implementing various embodiments. The communications system 100 may comprise multiple elements. An element may comprise any physical or logical structure arranged to perform certain operations. Each element may be implemented as a hardware element, a software element, or any combination thereof, as desired for a given set of design parameters or performance constraints. Examples of hardware elements may include without limitation devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include without limitation any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although the communications system 100 as shown in FIG. 1 has a limited number of elements in a certain topology, it may be appreciated that the communications system 100 may include more or less elements in alternate topologies as desired for a given implementation. The embodiments are not limited in this context.

As shown in the illustrated embodiment of FIG. 1, the communications system 100 comprises a public network 110, a perimeter network 120, and a private network 130. The public network 110 may comprise any network accessible to a general class of users without discrimination. An example of the public network 110 may include the Internet. The private network 130 may comprise any network accessible to a limited class of users with discrimination between users and controlled access. An example of the private network 130 may include a network for a business entity, such as an enterprise network. A perimeter network 120 may comprise any network accessible by both a general class of users and a limited class of users using respective public and private interfaces, thereby providing some measure of interoperability between the networks 110, 130.

In various embodiments, the networks 110, 120 and 130 may each comprise packet-switched networks capable of supporting multimedia communications between various network devices, such as a Voice Over Internet Protocol (VoIP) or Voice Over Packet (VOP) (collectively referred to herein as “VoIP”) communication session. For example, the various elements of the networks 110, 120 and 130 may be capable of establishing a VoIP peer-to-peer telephone call or multi-party conference call using various types of VoIP technologies. In one embodiment, for example, the VoIP technologies may include a VoIP signaling protocol as defined and promulgated by the Internet Engineering Task Force (IETF) standards organization, such as the Session Initiation Protocol (SIP) as defined by the IETF series RFC 3261, 3265, 3853, 4320 and progeny, revisions and variants. In general, the SIP signaling protocol is an application-layer control and/or signaling protocol for creating, modifying, and terminating sessions with one or more participants. These sessions include IP telephone calls, multimedia distribution, and multimedia conferences. In one embodiment, for example, the VoIP technologies may include a data or media format protocol, such as the Real-time Transport Protocol (RTP) and Real-time Transport Control Protocol (RTCP) as defined by the IETF RFC 3550 and progeny, revisions and variants. The RTP/RTCP standard defines a uniform or standardized packet format for delivering multimedia information (e.g., audio and video) over a packet-switched network, such as the packet-switched networks 110, 120 and 130. Although some embodiments may utilize the SIP and RTP/RTCP protocols by way of example and not limitation, it may be appreciated that other VoIP protocols may also be used as desired for a given implementation.

In various embodiments, the various elements of the networks 110, 120 and 130 may perform various types of multimedia communications between various elements of the networks 110, 120 and 130. The multimedia communications may include communicating different types of information over a packet-switched network in the form of discrete data sets, such as packets, frames, packet data units (PDU), cells, segments or other delimited groups of information. The different types of information may include control information and media information. Control information may refer to any data representing commands, instructions or control words meant for an automated system. For example, control information may be used to route media information through a system, or instruct a node to process the media information in a predetermined manner. Media information may refer to any data representing content meant for a user. Examples of content may include, for example, data from a voice conversation, videoconference, streaming video, electronic mail (“email”) message, voice mail message, alphanumeric symbols, graphics, pictures, images, video, audio, text and so forth. Data from a voice conversation may be, for example, speech information, silence periods, background noise, comfort noise, tones and so forth. Although the networks 110, 120 and 130 are primarily implemented as packet-switched networks, in some cases one or more of these networks may have suitable interfaces and equipment to support various circuit-switched networks, such as the Public Switched Telephone Network (PSTN), for example.

In various embodiments, the public network 110 may include one or more public clients 112. The public client 112 may be implemented as a part, component or sub-system of an electronic device having a public network address. Examples for electronic devices suitable for use as the public client 112 may include, without limitation, a processing system, computer, server, work station, appliance, terminal, personal computer, laptop, ultra-laptop, handheld computer, personal digital assistant, television, digital television, set top box, telephone, mobile telephone, cellular telephone, handset, wireless access point, base station, subscriber station, mobile subscriber center, radio network controller, conference system, router, hub, gateway, bridge, switch, machine, or combination thereof.

In various embodiments, the private network 130 may include one or more private clients 132-1-m. The private clients 132-1-m may be implemented as a part, component or sub-system of an electronic device having a private network address, which is a network address generally known to the private network 130 but not publicly routable. Examples for electronic devices suitable for use as the private clients 132-1-m may include the same or similar electronic devices provided with reference to the public client 112. As shown in the illustrated embodiment of FIG. 1, for example, the private clients 132-1-m may include a peer client 132-1 and a conference server 132-2. The peer client 132-1 may comprise a peer device to the public client 112, and may be used as a multimedia end point to terminate a VoIP telephone call. For example, the peer client 132-1 may comprise a packet-switched telephone, such as a VoIP phone or SIP phone. The conference server 132-2 may comprise a multimedia conferencing server to support multiple VoIP telephone calls for a multimedia conference session between multiple multimedia end points, such as two or more public clients and/or peer clients. The conference server 132-2 may include, or be communicatively coupled to, various conference system components suitable for establishing, managing and terminating VoIP conference calls, such as a conference focus, one or more audio video multipoint control units (AVMCUs), gateways, bridges and so forth.

In various embodiments, the private network 130 may include a registration server 136. The registration server 136 is a centralized entity that is responsible for various network management operations for the private network 130, such as authenticating users, routing requests inside the private network 130, maintaining the Active Directory for a server operating system, and so forth. For example, before routing, the registration server 136 validates all requests that through it and ensures that the Uniform Resource Identifier (URI) in the FROM field of the SIP header of any registration requests matches the identity of the requester. In one embodiment, for example, the registration server 136 may be implemented using a MICROSOFT® OFFICE COMMUNICATIONS SERVER, made by Microsoft Corporation, Redmond, Wash. In this implementation, the clients 112, 132 may be implemented as a MICROSOFT OFFICE COMMUNICATOR CLIENT, also made by Microsoft Corporation, Redmond, Wash. The embodiments, however, are not limited to these examples.

In various embodiments, the perimeter network 120 may include various network devices to facilitate interoperability operations between devices within the networks 110, 130, such as the public client 112 and the private clients 132-1-m. In some embodiments, the perimeter network 120 may comprise network devices having public network interfaces accessible from the public client 112 from the public network 110, and private network interfaces accessible from the private clients 132-1-m.

In various embodiments, the perimeter network 120 may include a proxy server 122. The proxy server 122 may generally control access to the private network 130. The proxy server 122 is a server that accepts client requests from the public Internet and routes it to the appropriate destination based on the client request. It also validates a client request before forwarding. For example, the proxy server 122 may operate as a connection point for external or public clients for various VoIP operations, such as SIP signaling. In one embodiment, for example, the proxy server 122 provides an authenticated and secure SIP channel to discover the location of, and obtain authentication credentials for, a STUN relay service provided by the relay server 124 in multimedia communications systems, such as the communications system 100. The SIP clients or User Agents (UA) may be on a public network or a private network, such as respective networks 110, 130. The authentication credentials may be obtained either in a first party manner by a given client for use by itself, or alternatively, in a third party manner where a given client obtains authentication credentials on behalf of another client, such as for adding a client to a conference call system. In the latter case the third party should be authenticated and authorized to obtain this information on behalf of others. The proxy server 122 ensures that communications on the channel used to obtain the authentication credentials are secure and external or public clients are authenticated.

In various embodiments, the perimeter network 120 may include one or more network devices to implement NAT and/or firewall operations. Such operations are typically performed by devices disposed between the public network 110 and the private network 130. In some cases, these operations are typically performed by devices disposed between the public network 110 and the proxy server 122, as indicated by the dashed line 121. In the illustrated embodiment shown in FIG. 1, for example, the perimeter network 120 includes the NAT 128. Although the topology of the illustrated embodiment in FIG. 1 shows the NAT 128 parallel to the proxy server 122, it may be appreciated that the NAT 128 may be positioned between the proxy server 122 and the public network 110 as indicated by the dashed line 121. The embodiments are not limited in this context.

The NAT 128 may implement various NAT operations for the private network 130. The NAT 128 may re-write the source and/or destination addresses of network packets as they pass between the networks 110, 130. In this manner, the NAT 128 allows multiple hosts (e.g., the private clients 132-1-m) on the private network to access the public network 110 using a single public network address, such as an IP address. The NAT 128, however, sometimes makes it difficult to provide connectivity between the public client 112 and the private clients 132-1-m for a number of reasons, such as security issues since the public client 112 is unknown to the private network 130, difficulty in obtaining a network address for a client behind a NAT device, overhead costs, and so forth. Similarly, the private network 130 may be protected by a corporate firewall that prevents outside users from gaining access to the resources of the private network 130. The corporate firewall may also make it difficult to provide connectivity between clients 112, 132.

To compensate for end-to-end connectivity problems, the perimeter network 120 may implement a relay server 124 to allow the public client 112 to traverse a corporate firewall and/or the NAT 128. The relay server 124 may be any electronic device as previously described with respect to the clients 112, 132 arranged to communicate any data such as media information between various media end points or destinations (e.g., clients 112, 132). In one embodiment, for example, the relay server 124 may be arranged to operate in accordance with the Internet Engineering Task Force (IETF) Session Utilities for NAT (STUN) protocol, as defined by the IETF RFC 3489 and its progeny, revisions and variants. When implementing the STUN protocol, the relay server 124 may sometimes be referred to as a STUN server. The STUN protocol provides a suite of tools for facilitating the traversal of the NAT device 128. Specifically, it defines the Binding Request, which is used by a client to determine its reflexive transport address towards the STUN server. The reflexive transport address can be used by the client for receiving packets from peers, but only when the client is behind a certain type of NAT. In particular, if a client is behind a type of NAT whose mapping behavior is address or address and port dependent, then the reflexive transport address will not be usable for communicating with a peer. In this case, the only way to obtain a transport address that can be used for corresponding with a peer through such a NAT is to make use of a relay, such as a relay server 124. The relay server 124 sits on the public side of the NAT device 128, and allocates transport addresses to clients reaching it from behind the private side of the NAT device 128 (e.g., network 130). These allocated addresses are from interfaces on the relay server 124. When the relay server 124 receives a packet on one of these allocated addresses, the relay server 124 forwards it toward the client.

In addition to the STUN protocol, the relay server 124 may be arranged to implement an extension of the STUN protocol referred to as the IETF Traversal Using Relays around NAT (TURN), as defined by the IETF Internet Draft titled “Traversal Using Relays around NAT (TURN): Relay Extensions to Session Traversal Utilities for NAT (STUN)”, Jul. 8, 2007, and its progeny, revisions and variants. The TURN protocol allows a client to request an address on the STUN server itself, so that the STUN server acts as a relay. To accomplish that, this extension defines a handful of new STUN requests and indications. The ALLOCATE REQUEST is a fundamental component of this set of extensions. It is used to provide the client with a transport address that is relayed through the STUN server. A transport address which relays through an intermediary is called a relayed transport address. A STUN server that supports these extensions is sometimes referred to as a “STUN relay” or more simply a “TURN server.” When the relay server 124 is configured for operation as a TURN server, the public client 112 and the private clients 132-1-m may be arranged to operate as TURN clients, in accordance with the TURN protocol. The TURN clients can communicate with a TURN server using any number of suitable communications transports, such as the User Datagram Protocol (UDP), Transmission Control Protocol (TCP), or Transport Layer Security (TLS) over TCP. In some cases, a TURN server can even relay traffic between two different transports with certain restrictions.

To operate using the TURN protocol, the relay server 124 needs to authenticate the clients 112, 132 prior to allowing the clients 112, 132 to begin communicating media information through the relay server 124. The relay server 124 performs authentication operations for the clients 112, 132 using a shared secret between the relay server 124 and the respective clients 112, 132. The relay server 124 typically generates the shared secret, and distributes the shared secret to the clients 112, 132. In some cases, however, it may be difficult for the public client 112 to securely obtain the shared secret generated by the relay server 124.

To solve these and other problems, the relay server 124 may include a relay server authentication service (RSAS) module 126. The RSAS module 126 typically resides in the relay server 124, although not necessarily in all cases. The RSAS module 126 shares a security or bank certificate with the relay server 124. The RSAS module 126 uses the bank certificate to create tokens for the TURN clients. The relay server 124 uses the bank certificate to validate tokens presented by the TURN clients. Assuming other elements of the private network 130 validates the identity of the person sending the requests, such as the registration server 136, the RSAS module 126 does not need to perform any additional authentication for the client as it responds to the clients only on the internal interfaces, and any request that arrives at the RSAS module 126 goes through the registration server 136.

The RSAS module 126 may be arranged to perform authentication operations for the TURN clients 112, 132. The RSAS module 126 may generate authentication information for the clients 112, 132. The authentication information may comprise any defined information defined by a given cryptographic or security technique for security operations. The authentication information may also be sometimes referred to herein as security tokens or credentials. More particularly, the RSAS module 126 may be arranged to receive an authentication request for public client authentication information from a private client 132-1-m on behalf of a public client 112 attempting to traverse a NAT 128. The RSAS module 126 may generate the public client authentication information for the public client 112, and send an authentication response with the public client authentication information to the private client 132-1-m. The private client 132-1-m may forward the public client authentication information to the public client 112 through the proxy server 122. The public client 112 may then perform authentication operations with the relay server 124 to communicate media information between the public client 112 and the private client 132-1-m.

Prior to relaying media information between the clients 112, 132, the relay server 124 may perform authentication operations and checks for mandatory unknown attributes. For example, when the public client 112 has received the public client authentication information and seeks to communicate media information to the private client 132 through the relay server 124, the public client 112 sends an ALLOCATE REQUEST to the relay server 124. The ALLOCATE REQUEST, like most other STUN requests, can be sent to the relay server 124 (e.g., the TURN server) over UDP, TCP, or TCP/TLS transports. The relay server 124 may receive and begin processing the ALLOCATE REQUEST. Due to the fact that the STUN server is allocating resources for processing the request, the relay server 124 should authenticate the ALLOCATE REQUEST, and furthermore, it should authenticate the ALLOCATE REQUEST using either a shared secret known between the public client 112 and the relay server 124, or a short term password derived from it. Once the relay server 124 authenticates the credentials presented by the public client 112 with the ALLOCATE REQUEST, namely the public client authentication information, then the relay server 124 may send an ALLOCATE RESPONSE to the public client 112. The ALLOCATE RESPONSE may include an allocated transport address. The allocated transport address may comprise, for example, a public IP address and a port number mapped by the proxy server 122. Once it receives the allocated transport request, the public client 112 may then use a CONNECT REQUEST to ask the relay server 124 to open a TCP connection and/or a UDP connection to a specified destination address included in the request.

When the relay server 124 is implemented as a STUN server implementing the TURN extensions, the relay server 124 allocates bandwidth and port resources to clients. Therefore, a STUN server providing the relay usage requires authentication and authorization of STUN requests. This may be accomplished using authentication information known to both the relay server 124 and the clients 112, 132. The authentication information generated by the relay server 124 for the public client 112 may be referred to as public client authentication information. The authentication information generated by the relay server 124 for the private clients 132-1-m may be referred to as private client authentication information. The particular authentication operations and authentication information may vary according to a given implementation. In one embodiment, for example, the authentication operations and authentication information may be implemented in accordance with the STUN protocol as defined by one or more STUN standards or proposed standards, and their progeny, revisions and variants. For example, digest authentication and the usage of short-term passwords, obtained through a digest exchange over TLS, may be implemented by the relay server 124 and/or the clients 112, 132. The usage of short-term passwords ensures that the ALLOCTE REQUESTS, which often do not run over TLS, are not susceptible to offline dictionary attacks that can be used to guess the long lived shared secret between the client and the server. The embodiments, however, are not limited in this context.

Operations for the communications system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the communications system 100 or alternative elements as desired for a given set of design and performance constraints.

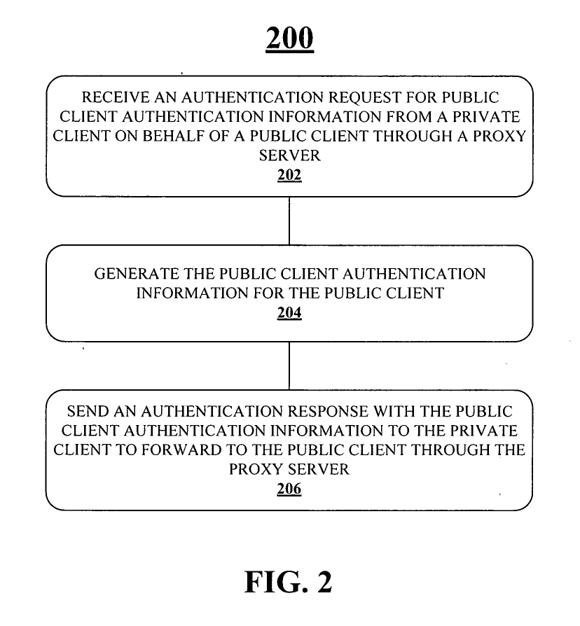

FIG. 2 illustrates a logic flow 200. The logic flow 200 may be representative of the operations executed by one or more embodiments described herein. As shown in FIG. 2, the logic flow 200 may receive an authentication request for public client authentication information from a private client on behalf of a public client attempting to traverse a proxy server at block 202. The logic flow 200 may generate the public client authentication information for the public client at block 204. The logic flow 200 may send an authentication response with the public client authentication information to the private client to forward to the public client through the proxy server at block 206. The embodiments are not limited in this context.

In one embodiment, the logic flow 200 may receive an authentication request for public client authentication information from a private client on behalf of a public client attempting to traverse a proxy server at block 202. For example, assume the public client 112 wants to initiate a VoIP communication session (e.g., a VoIP telephone call) with the peer client 132-1. To accomplish this, the public client 112 needs to traverse the NAT 128. Consequently, the public client 112 may initiate a SIP signaling flow with the peer client 132-1 to establish the VoIP communication session. Within the SIP signaling flow, the peer client 132-1 may send a SIP SERVICE REQUEST message to the relay server 124 as the authentication request.

In one embodiment, the logic flow 200 may generate the public client authentication information for the public client at block 204. For example, the relay server 124 may receive the SIP SERVICE REQUEST message, and generate the public client authentication information for the public client 112. The public client authentication information may include a shared secret generated in accordance with a desired encryption or security technique, such as those defined by the STUN standards and proposed standards.

In one embodiment, the logic flow 200 may send an authentication response with the public client authentication information to the private client to forward to the public client through the proxy server at block 206. For example, the relay server 124 may send a SIP SERVICE RESPONSE message to the peer client 132-1 in response to the SIP SERVICE REQUEST message previously received from the peer client 132-1. The SIP SERVICE RESPONSE message may include an internal interface for itself, and an external interface for the client. For example, the external interface may include a Fully Qualified Domain Name (FQDN) or IP address for the relay server 124. The peer client 132-1 may then forward the public client authentication information and external interface to the public client 112 via the proxy server 122.

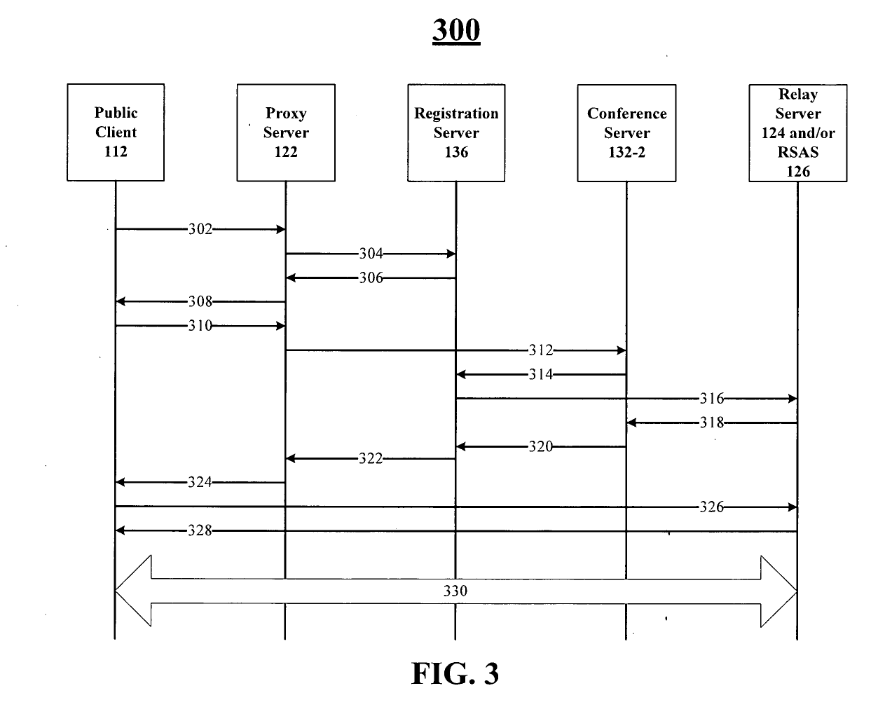

FIG. 3 illustrates a message flow 300. The message flow 300 may be representative of a message flow between various elements of the communications system 100 as described with reference to FIG. 1. More particularly, the message flow 300 may provide a broader example of the message flow and operations of the communications system 100. Prior to communicating with one of the private clients 132-1-m, the public client 112 first registers with the registration server 136, which in turn authenticates the public client 112. When the public client 112 needs to establish multimedia communication (e.g., audio and/or video) with either the conference server 132-2 in a conferencing scenario or the peer client 132-1 in a peer-to-peer calling scenario, the public client 112 needs to access the relay server 124, which relays media information across the NAT 128. To prove their identity to the relay server 124, the public client 112 obtains authentication information in the form of a security token from the private network 130 infrastructure, and identifies itself at the relay server 124, which validates the security token before allocating a port for the public client 112 to relay information.

For enhanced security, the TLS protocol may be used for signaling during the security token request operations by the public client 112, as well as within the whole infrastructure of the private network 130. The TLS protocol prevents tokens from being “sniffed out” or intercepted during transport. The security tokens typically have a limited lifetime, and the relay server 124 typically limits the number of ports allocated by a single client at a particular instant. This prevents an attacker from launching a denial-of-service (DOS) or other major attack on the relay server 124 even if the attacker manages to get a valid security token from the RSAS module 126.

As shown in FIG. 3, the message flow 300 assumes a new caller such as the public client 112 of the public network 110 would like to join a multimedia conference call managed by a conference server 132-2 of the private network 130. The public client 112 sends a REGISTER REQUEST to the proxy server 122 to register the public client 112 with the private network 130, as indicated by the arrow 302. The proxy server 122 passes the REGISTER REQUEST to the registration server 136 as indicated by the arrow 304. The registration server 136 authenticates the public client 112, and sends a REGISTER RESPONSE message to the proxy server 122 as indicated by the arrow 306. The REGISTER RESPONSE message may also return a SIP Globally Routable User Agent URI (GRUU) address (e.g., inside and outside) as the address for the relay server 124. The proxy server 122 forwards the REGISTER RESPONSE message to the public client 112 as indicated by the arrow 308. When an operator of the public client 112 desires to join a conference call, the public client 112 contacts the RSAS module 126 for a security token using the GRUU of the RSAS module 126 and the registration server 136 as a proxy.

The public client 112 sends an ADDUSER REQUEST to the proxy server 122 as indicated by the arrow 310. The proxy server 122 forwards the ADDUSER REQUEST to the conference server 132-2 as indicated by the arrow 312. The conference server 132-2 sends a SIP SERVICE REQUEST on behalf of the public client 112 to the relay server 124 using the registration server 136 as a proxy, as indicated by the arrow 314. The registration server 136 validates the FROM URI in the SIP header with the client's identity, which prevents clients from spoofing their FROM SIP header. The registration server 136 resolves the GRUU to the FQDN and port number of the RSAS module 126, and forwards the SIP SERVICE REQUEST to the RSAS module 126 as indicated by the arrow 316. The SIP SERVICE REQUEST contains the identity for which the token is needed, duration for which the token needs to be valid, and where the client resides (e.g., Internet or Intranet). The RSAS module 126 identifies that the SIP SERVICE REQUEST comes from a trusted server (e.g., the registration server 136), and generates the appropriate credentials. The RSAS module 126 sends the credentials to the conference server 132-2 as indicated by the arrow 318. The conferencing server 132-2 adds the public client 112 to the conference call, and sends an ADDUSER RESPONSE with the credentials to the registration server 136 as the proxy, as indicated by the arrow 320. The registration server 136 may forward the ADDUSER RESPONSE to the proxy server 122, as indicated by the arrow 322. The proxy server 122 forwards the ADDUSER RESPONSE to the public client 112, as indicated by the arrow 324.

An example of a SIP SERVICE REQUEST suitable for use in obtaining credentials from the RSAS module 126 upon receipt of an ADDUSER REQUEST is shown as follows:

```
SERVICE sip:RSAS.microsoft.com SIP/2.0
Via: SIP/2.0/TLS 1.2.3.4:1234
Max-Forwards: 70
From:
<sip:conf1@avmcu.microsoft.com>;tag=12345abcde;epid=12345abcde
To: <sip:RSAS.microsoft.com>
Call-ID: 19400d6cc8074a2d9cd32950cc856981
CSeq: 1 SERVICE
Contact:
<sip:avmcu.microsoft.com:1234;maddr=1.2.3.4;transport=tls>;proxy=
replace
Content-Type: application/msrtc-media-relay-auth+xml
Content-Length: ...
<request
  requestID=“1”
  version=“1.0”
  to=“sip:RSAS.microsoft.com”
  from=“sip:conf1@avmcu.microsoft.com”
  xmlns:xsi=“http://www.w3.org/2001/XMLSchema-instance”
  xmlns=“http://schemas.microsoft.com/2006/09/sip/RSASp”>
  <credentialsRequest credentialsRequestID=“1”>
    <identity>conf1@avmcu.microsoft.com</identity>
    <location>intranet</location>
  </credentialsRequest>
  <credentialsRequest credentialsRequestID=“2”>
    <identity>user@contoso.com</identity>
    <location>internet</location>
  </credentialsRequest>
</request>
```

The RSAS module 126 of the relay server 124 checks to see whether the request comes from a trusted server or a client based on the FROM URI. Trusted servers such as the conference server 132-2 can request tokens on behalf of other clients, whereas clients such as the peer client 132-1 are typically limited to requesting tokens only for themselves. In the latter case, the peer client 132-1 may or may not request a security token on behalf of the public client 112, depending upon a given implementation. If the peer client 132-1 is arranged to request security tokens from the RSAS module 126 on behalf of the public client 112, then the message flow may be implemented using the messages indicated by the arrows 314, 316 and 318. If the peer client 132-1 is not arranged to request security tokens from the RSAS module 126 on behalf of the public client 112, however, then the registration server 136 may act as a proxy and request the security token for the public client 112 directly from the RSAS module 126, thereby bypassing the message flow indicated by the arrows 314, 316 and 318.

Once the RSAS module 126 of the relay server 124 receives the SIP SERVICE REQUEST, the RSAS module 126 uses the shared certificate to generate security keys in accordance with a given security technique. For example, the RSAS module 126 may create a USERNAME and PASSWORD based on the following algorithm:

```
Two keys are generated
key1= hash the certificate serial number with the private key of
the certificate.
key2 = hash the certificate thumbprint with the private key of
the certificate.
A token structure is generated with the following fields: version, size of
the token structure, expiry time (current time + min (client supplied
duration, defaulttime), and hash of the client id.
Structure of token:
    Int16 version;
    Int16 size;
    Int32 expiryTime_low;
    Int32 expiryTime_high;
    byte[ ] hashClientID;
username = token structure appended with HMACSHA of this
token structure with key1
password = HMACSHA of the username with key2
```

It is worthy to note that HMACSHA is a type of keyed hash algorithm that is constructed from the SHA1 hash function and used as a hash-based message authentication code (HMAC). It can be appreciated, however, that the RSAS module 126 may generate a USERNAME and PASSWORD for the public client 112 using other security techniques as well depending upon a desired level of security for a given implementation. The embodiments are not limited in this context.

Once the RSAS module 126 generates the public client authentication information for the public client 112 (e.g., the security token), the relay server 124 passes these credentials to the public client 112, along with the information regarding the relay server 124 as described with reference to FIG. 2. For example, the relay server 124 may send a SIP SERVICE RESPONSE to the conference server 132-2 as indicated by the arrow 318. An example of a format for the SIP SERVICE RESPONSE suitable for use in receiving credentials from the RSAS module 126 is shown as follows:

```
SIP/2.0 200 OK
Authentication-Info: NTLM
rspauth=“01000000303A33307207FE253D925414”,
srand=“3F329CF3”, snum=“6”, opaque=“D61DF004”, qop=“auth”,
targetname=“red-lsapf-02.exchange.corp.microsoft.com”, realm=“SIP
Communications Service”
Via: SIP/2.0/TLS 1.2.3.4:1234;received=1.2.3.4;ms-received-
port=32982;ms-received-cid=374000
From: <sip:avmcu.microsoft.com>;tag=12345abcde;epid=12345abcde
To:<sip:RSAS.microsoft.com>;tag=43381EB187C037D9E7D3F7B3B36
C2C17
Call-ID: 19400d6cc8074a2d9cd32950cc856981
CSeq: 1 SERVICE
Content-Length: ...
<response
  requestID=“1”
  version=“1.0”
  to=“sip:RSAS.microsoft.com”
  from=“sip:conf1@avmcu.microsoft.com”
  responseCode=“success”
  reasonPhrase=“OK”
  xmlns:xsi=“http://www.w3.org/2001/XMLSchema-instance”
  xmlns=“http://schemas.microsoft.com/2006/09/sip/RSASp”>
  <credentialsResponse credentialsRequestID=“1”>
    <credentials>
      <username>12345abcde</username>
      <password>123345abcde</password>
      <duration>480</duration>
    </credentials>
    <mediaRelayList>
      <mediaRelay>
        <location>intranet</location>
        <hostName>mediarelay.corpnet.microsoft.com</hostName>
        <udpPort>3478</udpPort>
        <tcpPort>3478</tcpPort>
      </mediaRelay>
    </mediaRelayList>
  </credentialsResponse>
  <credentialsResponse credentialsRequestID=“2”>
    <credentials>
      <username>67890abcde</username>
      <password>67890abcde</password>
      <duration>480</duration>
    </credentials>
    <mediaRelayList>
      <mediaRelay>
        <location>internet</location>
        <hostName>mediarelay.microsoft.com</hostName>
        <udpPort>443</udpPort>
        <tcpPort>443</tcpPort>
      </mediaRelay>
    </mediaRelayList>
  </credentialsResponse>
</response>
```

The conference server 132-2 may pass the public client authentication information to the proxy server 122 using an ADDUSER RESPONSE message via the registration server 136 as a proxy, as indicated by the arrows 320, 322. The ADDUSER RESPONSE message may include the relay server FQDN or IP address. The proxy server 122 may forward the public client authentication information to the public client 112 using the ADDUSER RESPONSE message as indicated by the arrow 324.

Once the public client 112 receives the public client authentication information, the public client 112 may perform TURN operations with the relay server 124 using the USERNAME and PASSWORD. This may be accomplished, for example, by embedding the USERNAME in a TURN message, and calculating the message integrity of the whole message based on the PASSWORD. The public client 112 may send an ALLOCATE REQUEST with the embedded USERNAME to the relay server 124 using the FQDN of the relay server 124 received with the public client authentication information, as indicated by the arrow 326.

The relay server 124 may receive the ALLOCATE REQUEST message with the public client authentication information from the public client 112. The relay server 124 may authenticate the public client 112 using the public client authentication information, since the relay server 124 shares the same certificate that the RSAS module 126. When a packet is received from the public client 112, the relay server 124 extracts the USERNAME from the packet. It generates the PASSWORD by doing a HMACSHA on the USERNAME with key2. The relay server 124 verifies the message integrity of the packet using the generated PASSWORD.

This particular security technique relies on the assumption that the USERNAME and PASSWORD are transmitted in a TLS connection to the public client 112 from the RSAS module 126, so that they are not sniffed out from the network by an attacker. Further, the public client 112 embeds the USERNAME and uses the PASSWORD to generate message integrity in the packet. The PASSWORD is not transmitted. Since the USERNAME is embedded in the packet, tampering with the USERNAME will change the message integrity which can then be detected by the relay server 124. Since the PASSWORD is never transmitted in clear text anywhere in the communication path, the attacker has no way of regenerating the TURN packet with valid message integrity if the attacker alters the packet. Even if the credentials are leaked, they are valid only for a limited time. Furthermore, the relay server 124 imposes the restriction that will allow only a limited number of ports per client, thereby further reducing the potential success of an attack.

Once the relay server 124 verifies the credentials presented by the public client 112, the relay server 124 may send an ALLOCATION RESPONSE message with a public client allocated transport address to the public client 112 as indicated by the arrow 328. The public client allocated transport address may comprise, for example, a public network address and a port number for the relay server 124.

Similarly, the conference server 132-2 may send an ALLOCATION REQUEST message with private client authentication information generated by the RSAS module 126 to the relay server 124. The private client authentication information may be similar to the public client authentication information, and in some cases, may have reduced or eliminated security measures since the conference server 132-2 is a trusted server for the private network 130. The relay server 124 may send an ALLOCATION RESPONSE message with a private client allocated transport address from the relay server 124 to the conference server 132-2.

Once the public client 112 establishes a connection with the relay server 124 from the public network 110, and the conference server 132-2 establishes a connection with the relay server 124 from the private network 130, then the clients 112, 132-2 may begin communicating media information through the relay server 124, as indicated by arrow 330. The same or similar operations may be performed by the peer client 132-1 when the public client 112 and the peer client 132-1 desire to establish a peer-to-peer communication session.

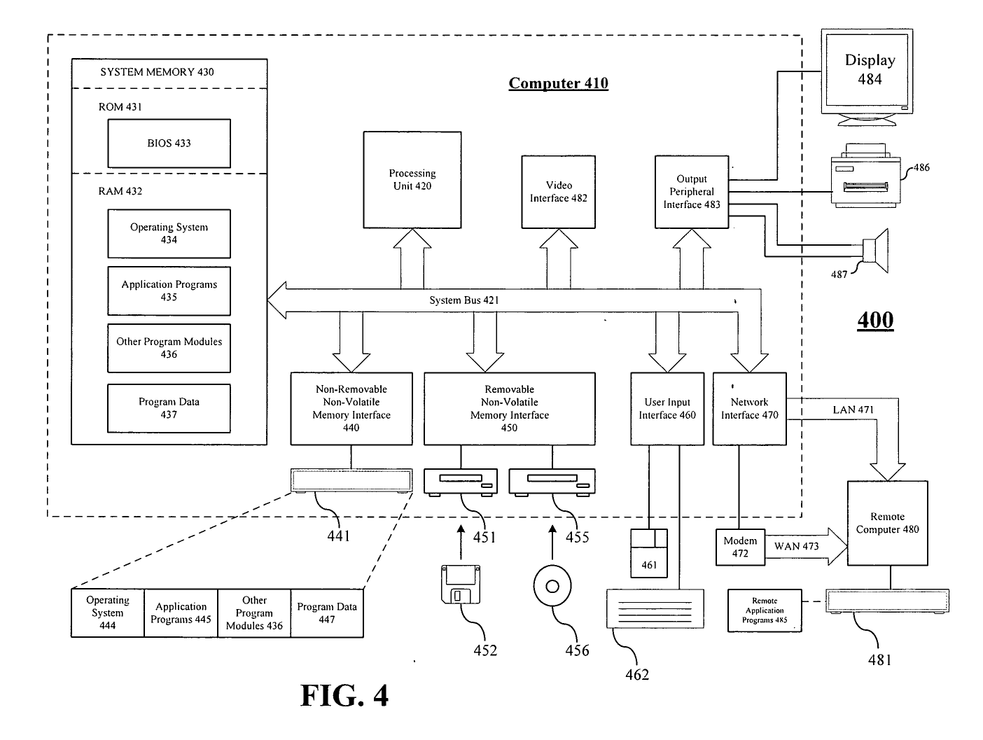

FIG. 4 illustrates a block diagram of a computing system architecture 400 suitable for implementing various embodiments, including the communication system 100. It may be appreciated that the computing system architecture 400 is only one example of a suitable computing environment and is not intended to suggest any limitation as to the scope of use or functionality of the embodiments. Neither should the computing system architecture 400 be interpreted as having any dependency or requirement relating to any one or combination of components illustrated in the exemplary computing system architecture 400.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 4, the computing system architecture 400 includes a general purpose computing device such as a computer 410. The computer 410 may include various components typically found in a computer or processing system. Some illustrative components of computer 410 may include, but are not limited to, a processing unit 420 and a memory unit 430.

In one embodiment, for example, the computer 410 may include one or more processing units 420. A processing unit 420 may comprise any hardware element or software element arranged to process information or data. Some examples of the processing unit 420 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 420 may be implemented as a general purpose processor. Alternatively, the processing unit 420 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 410 may include one or more memory units 430 coupled to the processing unit 420. A memory unit 430 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 410. The embodiments are not limited in this context.

In one embodiment, for example, the computer 410 may include a system bus 421 that couples various system components including the memory unit 430 to the processing unit 420. A system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 410 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 400. Examples of computer readable media for computing system architecture 400 may include, but are not limited to, volatile and/or nonvolatile memory such as ROM 431 and RAM 432. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 430 includes computer storage media in the form of volatile and/or nonvolatile memory such as ROM 431 and RAM 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable, volatile/nonvolatile computer storage media. By way of example only, FIG. 4 illustrates a hard disk drive 440 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide-storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 484 or other type of display device is also connected to the system bus 421 via an interface, such as a video processing unit or interface 482. In addition to the monitor 484, computers may also include other peripheral output devices such as speakers 487 and printer 486, which may be connected through an output peripheral interface 483.

The computer 410 may operate in a networked environment using logical connections to one or more remote computers, such as a remote computer 480. The remote computer 480 may be a personal computer (PC), a server, a router, a network PC, a peer device or other common network node, and typically includes many or all of the elements described above relative to the computer 410, although only a memory storage device 481 has been illustrated in FIG. 4 for clarity. The logical connections depicted in FIG. 4 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other technique suitable for establishing communications over the WAN 473, such as the Internet. The modem 472, which may be internal or external, may be connected to the system bus 421 via the network interface 470, or other appropriate mechanism. In a networked environment, program modules depicted relative to the computer 410, or portions thereof, may be stored in the remote memory storage device. By way of example, and not limitation, FIG. 4 illustrates remote application programs 485 as residing on memory device 481. It will be appreciated that the network connections shown are exemplary and other techniques for establishing a communications link between the computers may be used. Further, the network connections may be implemented as wired or wireless connections. In the latter case, the computing system architecture 400 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the computing system architecture 400 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving an authentication request for public client authentication information from a private client on behalf of a public client through a proxy server;
generating the public client authentication information for the public client; and
sending an authentication response with the public client authentication information to the private client to forward to the public client through the proxy server.

2. The method of claim 1, comprising authenticating the public client with the relay server using the public client authentication information.

3. The method of claim 1, comprising receiving an allocation request with the public client authentication information from the public client by the relay server.

4. The method of claim 1, comprising sending an allocation response with a public client allocated transport address from the relay server to the public client.

5. The method of claim 1, comprising receiving an allocation request with the public client authentication information comprising a user name and a password from the public client by the relay server.

6. The method of claim 1, comprising sending an allocation response with a public client allocated transport address comprising a public network address and a port number from the relay server to the public client.

7. The method of claim 1, comprising:
generating private client authentication information for the private client; and
sending the authentication response with the private client authentication information to the private client.

8. The method of claim 1, comprising:
receiving an allocation request with private client authentication information from the private client by the relay server; and
sending an allocation response with a private client allocated transport address from the relay server to the private client.

9. The method of claim 1, comprising communicating packets between the public client and the private client through the relay server.

10. An article comprising a storage medium containing instructions that if executed enable a system to:
receive a connection request to establish a communication session between a private client and a public client through a proxy server;
send an authentication request for public client authenticate information from the private client to a relay server;
receive an authentication response with the public client authentication information from the relay server by the private client; and
send a connection response with the public client authentication information from the private client to the public client through the proxy server.

11. The article of claim 10, comprising instructions that if executed enable the system to receive the authentication response with private client authentication information from the relay server by the private client.

12. The article of claim 10, comprising instructions that if executed enable the system to send an allocation request with the private client authentication information from the private client to the relay server.

13. The article of claim 10, comprising instructions that if executed enable the system to receive an allocation response with a private client allocated transport address from the relay server by the private client.

14. The article of claim 10, comprising instructions that if executed enable the system to communicate packets from the private client to the public client through the relay server using the private client allocated transport address.

15. A system, comprising:
a proxy server to receive an authentication request for client authentication information from a first client to traverse a network address translation device; and
a relay server to communicate packets between the first client and a second client, the relay server having a relay server authentication service module arranged to receive the authentication request from the proxy server, generate the client authentication information for the first client, and send an authentication response with the client authentication information to the first client through the proxy server.

16. The system of claim 15, the first client comprising a public client and the second client comprising a private client.

17. The system of claim 16, the private client having a private client authentication module, the private client authentication module arranged to receive a connection request to establish a communication session between the private client and the public client through the proxy server, send an authentication request for public client authenticate information to the relay server, receive an authentication response with the public client authentication information from the relay server, and send a connection response with the public client authentication information to the public client through the proxy server.

18. The system of claim 16, the private client having a private client authentication module, the private client authentication module arranged to send an authentication request for private client authenticate information to the relay server, and receive an authentication response with the private client authentication information from the relay server.

19. The system of claim 16, the private client having a private client authentication module, the private client authentication module arranged to send an allocation request with private client authentication information to the relay server, and receive an allocation response with a private client allocated transport address from the relay server.

20. The system of claim 16, the public client having a public client authentication module, the public client authentication module arranged to send an allocation request with the public client authentication information to the relay server, and receive an allocation response with a public client allocated transport address from the relay server.
